(19) United States
(12) Patent Application Publication
(10) Pub. No.: US 2017/0028255 A1
(43) Pub. Date: Feb. 2, 2017

(54) ACTIVITY AND SPORT SENSOR

(71) Applicants: Mica John Parks, Santa Ana, CA (US); Brian Michael Olson, Princeville, HI (US); Akhil Rao, Boulder, CO (US); Cody Lewis, Malden, MA (US); Shyama Dorbala, San Jose, CA (US); Jaysen Kim, Honolulu, HI (US)

(72) Inventors: Mica John Parks, Santa Ana, CA (US); Brian Michael Olson, Princeville, HI (US); Akhil Rao, Boulder, CO (US); Cody Lewis, Malden, MA (US); Shyama Dorbala, San Jose, CA (US); Jaysen Kim, Honolulu, HI (US)

(21) Appl. No.: 15/222,867

(22) Filed: Jul. 28, 2016

Related U.S. Application Data
(60) Provisional application No. 62/197,874, filed on Jul. 28, 2015.

(51) Int. Cl. A63B 24/00; G01C 19/42; A63B 71/06; G01P 13/00; A63B 71/02; G01P 15/18; G01C 13/00

(52) U.S. Cl. CPC A63B 24/0006; G01P 15/18; G01C 19/42; G01C 13/008; G01P 13/00; A63B 71/02; A63B 24/0062; A63B 71/0622; A63B 2225/60; A63B 2244/00; A63B 2208/03; A63B 2220/30; A63B 2220/62; A63B 2220/20; A63B 2220/40; A63B 2220/17

(57) ABSTRACT

Surf tracking and monitoring systems and methods. Surf tracking systems that incorporate a variety of sensors, including acceleration and rotation sensors, to track and monitor various aspects of a surfer's activities while in the water surfing including: depth of a duck dive, criticality of a turn while riding a wave, paddling efficiency, and so on. A motion capture element having the various sensors is affixed to the surface of a board. A computing device is used to interpret information from those sensors.

This application claims priority to U.S. Provisional Patent Application No. 62/197,874 filed Jul. 28, 2015 which is incorporated herein by reference in its entirety.

### FIELD OF THE INVENTION

The field of invention is activity and sports sensors.

### BACKGROUND

The background description includes information that may be useful in understanding the present invention. It is not an admission that any of the information provided in this application is prior art or relevant to the presently claimed invention, or that any publication specifically or implicitly referenced is prior art.

There is an increasing demand among individuals that participate in action sports such as surfing to record their motions using motion tracking systems. Typically built-in to a common device such as a cell phone, current motion tracking systems fall short of providing a single, integrated experience, especially for surfers. In addition to a need for a device capable of tracking surfing activities, there is also a need for a system that is capable of interpreting sensor information to give a surfer meaningful information about a surfing session.

WO2015172178A1 to Regan et al. describes at least one attempt to address these needs. While Regan et al. describes a device that can collect information from sensors regarding a surfer's session in the water, Regan et al. falls short. Notably, Regan et al. requires a user to fasten the device to their back. Having the device on a user's back severely limits the amount and types of useful sensor information that can be gathered, thereby limiting the number and types of metrics that can be generated based on the actions of the surfer during a session. Thus, there is still a need for an improved surf tracking and monitoring system.

All publications identified in this application are incorporated by reference to the same extent as if each individual publication or patent application were specifically and individually indicated to be incorporated by reference. Where a definition or use of a term in an incorporated reference is inconsistent or contrary to the definition of that term provided in this application, the definition of that term provided in this application applies and the definition of that term in the reference does not apply.

### SUMMARY OF THE INVENTION

In one aspect of the inventive subject matter, the inventors contemplate a surfing activity tracking system for use by a surfer with a board. In the context of this application, surfing is understood to be a water sport in which the wave rider, referred to as a surfer, rides on the forward or deep face of a moving wave, which is usually (but not always) carrying the surfer towards the shore. The term “surfing” can encompass sports such as bodyboarding, short boarding, long boarding, hydrofoil riding, stand up paddle boarding, skim boarding, and so on. Each of these activities has at least one commonality: they all include a board that the surfer uses as a vehicle to ride waves.

The surfing activity tracking system includes at least a motion capture element and a computing device. The motion capture element can have an acceleration sensor that detects acceleration along an x-axis, a y-axis, and a z-axis (where, when the motion capture element is affixed to a board, the x-axis runs from the front to the back of the board, the y-axis runs the width of the board, and the z-axis is normal to the surface of the board) and a rotation sensor that detects rotation about those same axes. The system also includes a computing device that uses sensor information received from the motion capture element to determine criticality of turns carried out by the surfer while riding waves, where criticality is a function of a dot product of acceleration data from the acceleration sensor with rotation data from the rotation sensor.

In some embodiments, the system also includes a waterproof housing to contain the motion capture element. The waterproof housing can be formed into a delta wing shape to reduce hydrodynamic drag when it is affixed to the surface of a board. In some embodiments, the motion capture element also includes a pressure sensor to detect a depth of the motion capture element in a body of water (e.g., a lake, an ocean, a river, a lagoon, an artificial body of water such as a pool, or any other body of water where surfing can take place).

In some embodiments, the computing device can be used to determine a variety of metrics that give insight into a surfing session. For example, the computing device can use sensor information received from the motion capture element to determine stroke efficiency of the surfer, where stroke efficiency is a function of at least a number of strokes per second and an acceleration along the x- and y-axes. In other embodiments, the computing device can use sensor information received from the motion capture element to determine a body position of the surfer on the board, where body position is a function of at least an acceleration along the x-axis and a rotation about the y-axis. In other embodiments, the computing device can use sensor information received from the motion capture element to determine a duck dive depth, where duck dive depth is a function of a double integration of the inner product of an acceleration along the x-axis and an acceleration along the z-axis.

In some embodiments, the motion capture element includes a display that can show: top speed (e.g., paddling speed or surfing speed), duration of time spent on a wave, distance traveled on a wave, top acceleration (e.g., acceleration dropping into a wave or acceleration experienced while turning on a wave), the number of turns executed on a wave, the duration of time spent paddling, the total duration of time spent riding waves, the total distance traveled in a body of water, and a total distance traveled while riding waves.

The inventors also contemplate a method of tracking surfing activity. The method includes the steps of: using an acceleration sensor contained within a motion capture element to measure accelerations along an x-axis, a y-axis, and a z-axis; using a rotation sensor contained within the motion capture element to measure rotations about the x-axis, the y-axis, and the z-axis; and determining a criticality of a turn carried out by the surfer using acceleration data measured by the acceleration sensor and rotation data measured by the rotation sensor, where the criticality of a turn is a function of a product of acceleration data from the acceleration sensor with rotation data from the rotation sensor. Some embodiments of the method include the additional step of affixing the motion capture element to the board.

In some embodiments, the method also includes the step of placing the motion capture element within a waterproof housing, where the waterproof housing has a delta wing shape to reduce hydrodynamic drag. The method can also include the step of using a pressure sensor to measure a depth of the motion capture element in a body of water.

In some embodiments, the method also includes the step of determining stroke efficiency of the surfer, where stroke efficiency of the surfer is a function of at least a number of strokes per second and an acceleration along the x- and y-axes. In still further embodiments, the method can include the step of determining a body position of the surfer on the board, where body position is determined as a function of at least an acceleration along the x-axis and a rotation about the y-axis. In some embodiments, the method also includes the step of determining a duck dive depth, where duck dive depth is a function of a double integration of the inner product of an acceleration along the x-axis and an acceleration along the z-axis.

Finally, the method can also include the step of displaying, via a display on the motion capture element, at least one of: a top speed, a duration of time spent on a wave, a distance traveled on a wave, a top acceleration, a number of turns executed on a wave, a duration of time spent paddling, a total duration of time spent riding waves, a total distance traveled in a body of water, and a total distance traveled while riding waves.

### BRIEF DESCRIPTION OF THE DRAWINGS

FIG. 1A shows an embodiment of a motion capture element within a waterproof housing placed on the nose of a surf board.

FIG. 1B shows an embodiment of a motion capture element within a waterproof housing placed on the nose of a surf board along with a representation of the x, y, and z axes of a Cartesian coordinate system.

FIG. 2 shows an embodiment of a motion capture within a waterproof housing having an accelerometer and a rotation sensor along with a representation of a computing device to interpret sensor information.

FIG. 3 shows an embodiment of a waterproof housing having a display visible to a surfer.

FIG. 4 shows an embodiment of a motion capture within a waterproof housing having an acceleration sensor, a rotation sensor, and a pressure sensor along with a representation of a computing device to interpret sensor information.

### DETAILED DESCRIPTION

As discussed above, the inventive subject matter of this application centers on an activity tracking system for surfers. The activity tracking system includes a motion capture element and a computing device. The motion capture element can include a variety of sensors including an acceleration sensor, a rotation sensor, a location sensor, and a pressure sensor. The motion capture element can be housed within a waterproof housing, and the waterproof housing affixed to the surface of a board (e.g. a surfboard, a bodyboard, a stand up paddle board, or other type of board that can be used to ride a wave). Once it is affixed to the surface of a board, the motion capture element takes measurements from its onboard sensors, and that information is used by the computing device to make determinations about different activities and actions undertaken by a surfer while surfing.

Throughout the following discussion, numerous references will be made regarding servers, services, interfaces, engines, modules, clients, peers, portals, platforms, or other systems composed of computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash drive, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

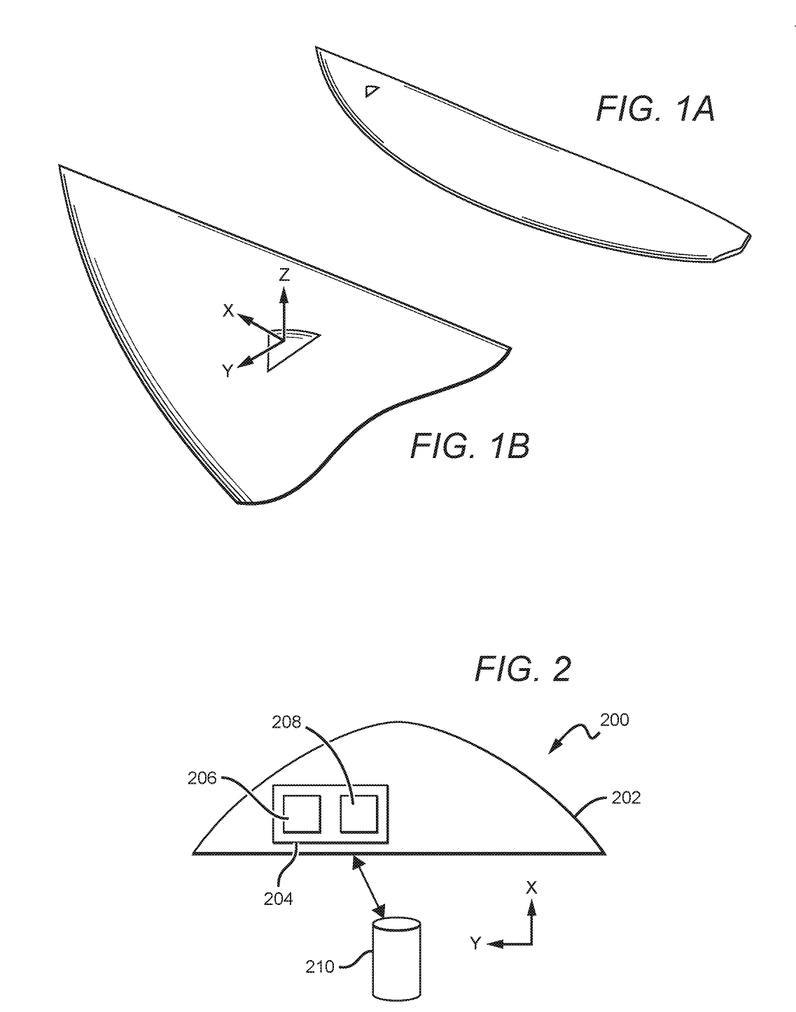

With a motion capture element contained within a waterproof housing, the waterproof housing can then be affixed to the surface of a board. In preferred embodiments, such as those seen in FIGS. 1A and 1B, the waterproof housing 100 is affixed to the nose portion of a board 102. The waterproof housing 100 can alternatively be affixed to other areas of the board 102 as well, such as the rear or the middle portion. Ideally, the waterproof housing 100 is mounted so that it is in the middle of the board centered along the x-axis (shown in FIG. 1B), as shown in both FIGS. 1A and 1B. The waterproof housing can be either permanently or removably affixed to the surfboard (e.g., affixed using an adhesive, a suction cup, or another nonpermanent means of affixing the waterproof housing to the board).

Affixing the waterproof housing containing the motion capture element on a board facilitates detection of events and characteristics such as paddle strokes, criticality of turns, stroke efficiency, the surfer's body position on the board, duck dive depth, and so on. It also facilitates periodicity adjustments to correct for detection of the board's movement with the ocean. In preferred embodiments, the waterproof housing is designed to be resistant to the corrosive effects of exposure to salt water, and it is designed to withstand high amounts of pressure that are experienced during activities like duck dives. As seen in FIGS. 1A and 1B, the waterproof housing 100 is formed into the shape of a delta wing in the interest of reducing hydrodynamic friction.

FIG. 2 shows a cutaway view of an embodiment of the system 200. In this embodiment, the system 200 includes a waterproof housing 202 that contains a motion capture element 204 having an acceleration sensor 206 and a rotation sensor 208. The system 200 also includes a computing device 210 which can be informationally coupled (e.g., via a wired or wireless connection) with the motion capture element 204 to facilitate interpretation of raw sensor data. Although depicted outside of the waterproof housing 202, the inventors contemplate that the computing device 210 could be housed within the waterproof housing 202. The computing device 210 could also exist separately (e.g., as a personal computer, a server, or mobile device, etc.). The rotation sensor can be any sensor that detects angular movement or rotation, such as a gyroscope (e.g., a MEMS gyroscope), and the acceleration sensor can be any sensor that detects acceleration (e.g., a MEMS accelerometer). These sensors are preferably capable of detecting accelerations and rotations along or about three different axes in a Cartesian coordinate system (e.g., x, y, and z as shown in FIG. 1B).

In still further embodiments of the system, additional sensors and electronics can be included. For example, a GPS sensor can be included. In embodiments with a GPS sensor, location data can be logged. Logging position information as a function of time makes it possible for a map of the surfer's position to be generated by a computing device, showing the location of the surfer on each wave and over the course of an entire surf session. As a note, this application should be interpreted such that any of the discussed sensors can be incorporated into any of the discussed embodiments of the motion capture element.

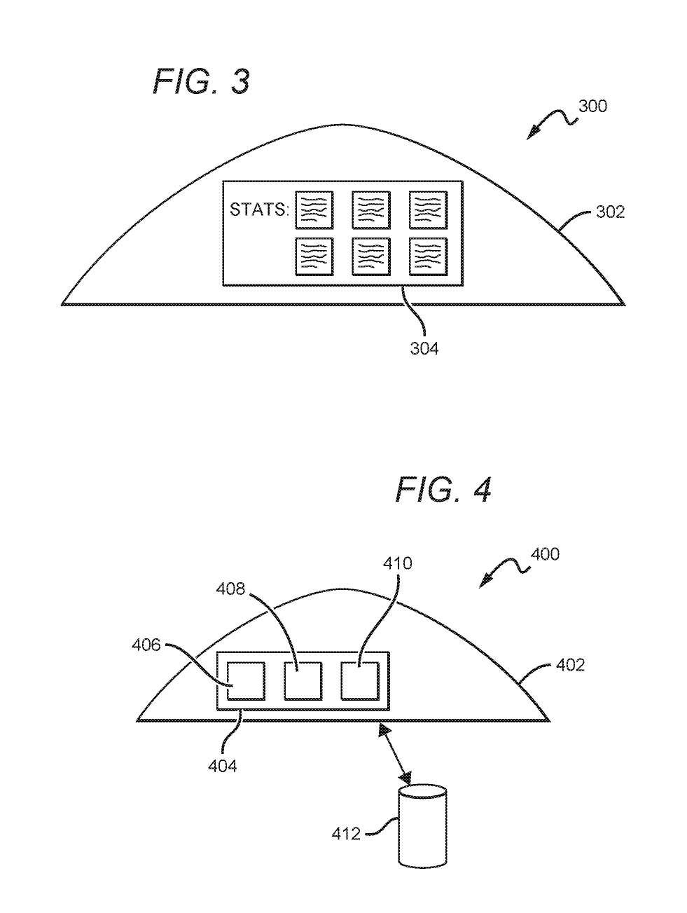

In some embodiments of the system, such as the embodiment shown in FIG. 3, the system 300 also includes a display 302 that is visible on a surface of the waterproof housing 304. The display 302 can display information pertinent to the surfer's session. For example, in some embodiments, the display 302 can show the surfer stats like maximum acceleration, maximum speed, a number of paddle strokes, and so on. The inventors contemplate that the display 302 could show any event or characteristic that is described in this application (e.g., a map of the surfer's location, criticality of turns, maximum speed, etc.). The display 302 could also be implemented to provide tips to the surfer. For example, the system 300 can be configured to detect when it is time for a surfer to get to their feet, and upon detecting that condition, the display 302 could display the words “POP UP.” For each of the events described in this application, a corresponding tip or suggestion could be generated and displayed to the surfer during use of the system 300 (e.g., “step forward,” “lean left,” “scoot forward on your board,” and so on).

FIG. 4 shows another embodiment of the system 400 having a motion capture element 404 that has a pressure sensor 406 in addition to the rotation sensor 408 and the acceleration sensor 410. As with other embodiments of the system, the motion capture element 404 is contained within a waterproof housing 402. The computing device 412 can either be contained within the waterproof housing, or it can operate externally as discussed above.

The inventors contemplate that systems described in this application can be used in a wide variety of ways. For example, the system can be used to provide accurate reporting of conditions at various surf spots. Once sensor information is interpreted by the computing device, the computing device can share things like stats, characteristics, events, and position information related to a remote server (e.g., to social media or other websites). In this way, competition can be fostered among local surfers by creating a leader board for particular spots. A leader board can show, for example, which surfer at a spot rode the longest wave, which surfer moved the fastest on a wave, and which surfer spent the most time in the water. Characterization of a spot can be performed by aggregating data from many different systems to determine, for example, how frequently set waves come in and how large those set waves actually are at different locations in the water at that surf spot.

With a motion capture element safely contained in a waterproof housing that is affixed to the surface of a board, the system can be used to detect various events. To detect events, the sensors within the motion capture element are used to collect raw information about movements of the board. Raw information is used by the computing device in conjunction with one or more machine learning algorithms, including for example random forests and hidden Markov models, to detect the occurrence of certain events. For purposes of this application, an “event” is a discrete occurrence or a characteristic that the system is designed to detect. For example a turn, a paddle stroke, a duration of time spent on a wave, body position on a board, and any other activity, occurrence, or characteristic described in this application as something the system is capable of detecting and characterizing can be considered an event.

Classification rules to determine occurrence of an event are generated by machine learning algorithms and involve using on the order of one hundred functions calculated over one second of sensor readings (where the term “sensor” is meant to encompass all contemplated sensors described in this application) including: estimated coefficients of regression models of the form “G-force=accl.x+accl.y+accl.z” (where accl.x, accl.y, and accl.z are acceleration vectors oriented along the x-axis, y-axis, and the z-axis within a reference frame defined by placement of the motion capture element on a board as seen in FIG. 1B), derivatives of one second averages of the sensor readings, one second variances of the sensor readings, the number of times the sensor reading crosses its mean in one second, the number of times the sensor reading crosses change between positive to negative in one second, one second frequency domain decompositions of the sensor readings, one second spectral entropy calculations of the sensor readings, and one second maxima and minima of each sensor element.

The quantity “G-force,” mentioned above, is calculated as the Euclidean norm of the accelerometer's accl.x, accl.y, and accl.z vectors. Most of the functions given above as examples produce a single output for a single input. The inventors also contemplate that some functions, such as frequency decompositions, can produce up to six outputs for a single input. Each function is used, for example, over each of six sensor readings (three readings from the acceleration sensors and three readings from the rotation sensor).

The classification rules discussed above and implemented for event detection primarily involve sensor measurement thresholds and averages of classifications based on sensor measurement thresholds. An algorithm to determine an event (e.g., a duck dive) can involve monitoring for a number of thresholds exceeded for some number of measurements (e.g., 10-20, 20-30, 30-40, 40-50, 50-60, 60-70, 70-80, 80-90, 90-100, 100-110, 110-120, 120-130, 130-140, 150-160, 160-200, 200-300, 300-400, and 400-500) from the onboard sensors (e.g., the acceleration sensor and the rotation sensor). For example, if a surfer is duck diving (i.e., pushing the board underwater to pass beneath a wave) the system can utilize a computing device to interpret sensor data to search for some number of threshold crossings (e.g., 50 or more) to identify an event such as a duck dive.

One of the challenges associated with the classification methods discussed in this application over simpler analytical models of surf events is that a “training library” of manually-classified events is required for successful implementation. Such a training library can be built by first videotaping hundreds of hours of surf sessions where each surfer had a motion capture element on their board, and then analyzing the footage to classify events. The advantage of this approach is the ability to classify and algorithmically detect events of arbitrary complexity even if an analytical model of the event cannot be formed. Using this technique, a user of the system could videotape their own surf session and use that footage to manually identify events, which then allows an implemented machine learning algorithm to “learn” when these events occur so that it can identify future events without manual identification.

In some embodiments, sensor data can be refined to reduce error and noise. This refinement can be carried by the computing device, but in some embodiments, it can be carried out within the motion capture element. In embodiments where the motion capture element refines the sensor data and/or reduces signal noise, the motion capture element can carry out these tasks using solid state circuit elements or it can make use of software operated on a microprocessor to improve signal quality.

An example of an event that the system can detect is the occurrence of a paddle stroke. A paddle stroke event is detected when a motion capture element affixed to a board experiences roll about its x-axis such that the x-axis angle crosses from positive to negative or vice versa, where the “zero” angle exists when the y-axis of the motion capture element is parallel to a level plane (e.g., an imaginary plane whose surface has a normal vector that aligns with the earth's gravitational field). Because the motion capture element is mounted on the surfboard with the x-axis running the length of the board, this is a consistent indicator of the board's roll (e.g., left to right roll).

Another example of an event that the system can detect is the extent of paddle roll. Paddle roll is the degree to which the motion capture element, when it is affixed to the surface of a board, rolls about its x-axis as mentioned above. In some embodiments, the absolute value of rotation about the x-axis can be measured in units of radians per second. In such embodiments, a measurement of roll about the x-axis of, for example, −4 rad/s implies the board has rolled more than a measurement of roll about the x-axis of −2 rad/s would likewise imply.

The amount of roll can be measured by integrating the rotation sensor's x-axis rotation measurement from a local minimum or local maximum (e.g., −2 rad/s or +4 rad/s) to zero. Because of integration error, this measurement can be noisy, but having magnitudes of local minima and local maxima of rotation about the x-axis is sufficient to enable ranking of roll about the x-axis that occurs during paddle strokes (e.g., a stroke with +2 rad/s has less roll than a stroke with +4 rad/s).

Another example of an event that the system can detect is stroke efficiency. Stroke efficiency is defined as the average de-meaned (where a “de-meaned” value is one where the average has been subtracted out of the measured value) x-axis positive acceleration at a given time divided by the product of strokes per second and average y-axis acceleration variance at that given time. In some embodiments, the average x-axis acceleration value over the paddling event is subtracted from the time-series of x-axis acceleration values, instead of the one second average.

All else held constant, stroke efficiency (1) increases as each stroke increases the surfer's forward acceleration, (2) decreases as the surfer uses more strokes per second, (3) increases as the surfer uses fewer strokes per second, (4) decreases as the surfboard yaws around more per second, and (5) increases as the surfboard yaws around less per second.

Specific “good” or “bad” values for stroke efficiency will depend on the surfer. The general principle is that a higher number is better, but a “good” value for a new surfer may be a “bad” value for an experienced surfer. The efficiency measurements technically have no upper bound, with a lower bound of zero, where efficiency is a dimensionless quantity.

When an event (e.g., stroke efficiency) is measured for a particular surfer over a period of time, additional metrics can be supplied to that surfer based on ongoing trends in the measured event. For example, an average efficiency per session and a trend in efficiency can be supplied to a surfer based on changes in stroke efficiency over time. By using regression models (e.g., stroke efficiency=surfer position on board+paddle roll) estimated over data from multiple sessions and multiple users, key drivers of a surfer's stroke efficiency can be identified so that suggestions can be generated for behaviors that would result in higher efficiency numbers for that particular surfer. For example, the system could suggest to the surfer that they roll too much or too little while paddling, encouraging them to correct the issue to increase efficiency.

Another example of an event that the system can detect is surfer position on board while paddling. The surfer's body position can be determined as a function of x-axis acceleration measurements and y-axis rotation measurements. For example, the further forward the surfer is positioned on the board while paddling, the lower (e.g., more negative) the average value of accelerometer x readings will be since the board will be pitched forward and the tail will be pointed slightly up. The further back the surfer is positioned on the board while paddling, the higher (e.g., more positive) the average value of acceleration along the x-axis will be since the board will be pitched slightly back and the nose will be pointed up. The further the surfer's center of mass is from the board's center of mass, the higher the y-axis rotation measurement variance (e.g., an amount of rotation about the y-axis from its zero rotation position, which is defined as a position where the x-axis is parallel to an imaginary plane whose surface is normal to the direction of gravity) will be during paddling. When the surfer is appropriately centered on the board, the y-axis rotation variance will be minimized while paddling, and the average of accelerometer x readings while the surfer is classified as lying flat on the board without moving will be close to zero.

In practice, y-axis rotation variance is unlikely to remain at zero due to the natural motion of the body of water the surfer and board are floating in (e.g., the ocean), but when the surfer is appropriately positioned on the board, the frequency decomposition of rotation about the y-axis will be close to the frequency decomposition of acceleration along the z-axis, indicating that the main source of variation in the board's forward/backward pitching motion is the same source of the motion that is pushing the board up and down. In some embodiments, this closeness is measured in terms of Kullback-Liebler divergence, with acceleration along the z-axis's frequency decomposition treated as the denominator and rotation about the y-axis's frequency decomposition treated as the numerator. Kullback-Liebler divergence is expected to be close to zero when the surfer's center of mass is close to the board's center of mass (e.g., because there would be no excess pitching caused by the surfer being positioned off-center on the board), and larger when the surfer is positioned further from the board's center of mass.

Another example of an event that the system can detect is criticality. Criticality is defined as the product of acceleration and x-axis rotation measurements from the rotation sensor. In some embodiments, acceleration in the context of determining criticality is calculated as the Euclidean norm of an acceleration vector (e.g., a vector having components in the x-direction, the y-direction, and the z-direction). Criticality increases as a surfer's turns while riding a wave on a board involve greater acceleration (e.g., the turns are sharper or executed at greater speeds), and decreases as the surfer's turns involve lesser acceleration (e.g., the turns are wider or slower).

Another example of an event that the system can detect is board stiffness. Board stiffness can be determined using a standardized “natural frequency modes” test. In this test, the board is placed flat on the ground with a motion capture element affixed to the board's surface (e.g., at the center of the board). Measurements from the acceleration and rotation sensors are collected while the board is stricken several times. The frequency response of the collected sensor information from the acceleration sensor is analyzed, particularly acceleration along the z-axis. The first natural frequency of the board is calculated using, for example, a rigid-body, single-degree-of-freedom formula that is applied to the frequency response information. This natural frequency has a one-to-one mapping to stiffness, and allows for computation of the board's stiffness.

Another example of an event that the system can detect is board buoyancy. Board buoyancy is determined by taking, for example, an average of z-axis acceleration measurements during periods when the surfer is not riding a wave or paddling (e.g., resting in the water) after adjusting the z-axis accelerations measurements for periodic motions attributable to natural movements of a body of water (described above), combined with information about the surfer's mass (e.g., from a user profile) and the board's mass (e.g., from a database of board characteristics). Taking the combined mass of the board and surfer and periodicity-adjusted z-axis acceleration measurements, it is possible to compute a buoyant force required for the board to float (i.e., the board's buoyancy). This calculation can be computed by, for example, a computing device as shown in FIGS. 2 and 4.

Periodicity-adjustment of, for example, z-axis acceleration readings can be accomplished by a number of methods such as Fourier decomposition, use of high-pass filters, and other methods that are known in the art. Periodicity-adjustment can help to obtain more precise acceleration measurements.

In some embodiments, high-pass filters can be implemented within the system to remove signals having frequencies lower than, for example, 0.1 Hz (assuming a standard of 6 waves per minute). The frequency cutoff can be calibrated by automatically collecting wind speed data from databases with up-to-date wind information (e.g., Surfline.com, or any other website having relevant weather information), and then using that data determine a likely wave frequency, which in turn helps determine an appropriate cutoff frequency. For example, winds of 12.9 m/s tend to produce waves with a frequency of about 0.1 Hz, while stronger winds of 20.6 m/s tend to produce waves with a frequency of about 0.07 Hz.

Another example of an event that the system can detect is the depth of a duck dive. When a duck dive is detected, the depth of that duck dive is calculated by, for example, double integrating an inner product of x-axis and z-axis acceleration. The inner product is scaled by estimating pitch using the following equation:

$$Pitch = α = {tan}^{- 1} ( \frac{{A}_{x 1}}{\sqrt{{( {A}_{y 1} )}^{2} + {( {A}_{z 1} )}^{2}}} )$$

A pitch-adjusted integration yields an estimate of the change in the boards vertical position as it moves through a duck dive. In some embodiments, such as the embodiment shown in FIG. 4, the motion capture element can additionally include a pressure sensor. A pressure sensor can also be used to determine how deep underwater a board travels during a duck dive or other activity that would cause the board to be submerged.

It should be apparent to those skilled in the art that many more modifications besides those already described are possible without departing from the inventive concepts in this application. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A surfing activity tracking system for use by a surfer with a board, comprising:
a motion capture element having:
an acceleration sensor that detects acceleration along an x-axis, a y-axis, and a z-axis;
a rotation sensor that detects rotation about the x-axis, the y-axis, and the z-axis;
a computing device that utilizes sensor information received from the motion capture element to determine a criticality of a turn carried out by the surfer; and
wherein the criticality is a function of a product of acceleration data from the acceleration sensor with rotation data from the rotation sensor.

2. The surfing activity tracking system of claim 1, further comprising a waterproof housing containing the motion capture element, wherein the waterproof housing has a delta wing shape to reduce hydrodynamic drag.

3. The surfing activity tracking system of claim 1, wherein the motion capture element further comprises a pressure sensor to detect a depth of the motion capture element in a body of water.

4. The surfing activity tracking system of claim 1, wherein the computing device further utilizes sensor information received from the motion capture element to determine stroke efficiency of the surfer, and wherein stroke efficiency of the surfer is a function of at least a number of strokes per second and an acceleration along the x and y axes.

5. The surfing activity tracking system of claim 1, wherein the computing device further utilizes sensor information received from the motion capture element to determine a body position of the surfer on the board, wherein the body position is determined as a function of at least an acceleration along the x-axis and a rotation about the y-axis.

6. The surfing activity tracking system of claim 1, wherein the computing device further utilizes sensor information received from the motion capture element to determine a duck dive depth, wherein the duck dive depth is determined as a function of a double integration of an inner product of an acceleration along the x-axis and an acceleration along the z-axis.

7. The surfing activity tracking system of claim 1, wherein the motion capture element further comprises a display that shows at least one of: a top speed, a duration of time spent on a wave, a distance traveled on a wave, a top acceleration, a number of turns executed on a wave, a duration of time spent paddling, a total duration of time spent riding waves, a total distance traveled in a body of water, and a total distance traveled while riding waves.

8. A method of tracking surfing activity of a surfer with a board, comprising:
using an acceleration sensor contained within a motion capture element to measure accelerations along an x-axis, a y-axis, and a z-axis;
using a rotation sensor contained within the motion capture element to measure rotations about the x-axis, the y-axis, and the z-axis;
determining a criticality of a turn carried out by the surfer using acceleration data measured by the acceleration sensor and rotation data measured by the rotation sensor; and
wherein the criticality is a function of a product of acceleration data from the acceleration sensor with angular data from the rotation sensor.

9. The method of claim 8, further comprising placing the motion capture element within a waterproof housing, wherein the waterproof housing has a delta wing shape to reduce hydrodynamic drag.

10. The method of claim 8, further comprising using a pressure sensor to measure a depth of the motion capture element in a body of water.

11. The method of claim 8, further comprising determining stroke efficiency of the surfer, wherein stroke efficiency of the surfer is a function of at least a number of strokes per second and an acceleration along the x and y axes.

12. The method of claim 8, further comprising determining a body position of the surfer on the board, wherein the body position is determined as a function of at least an acceleration along the x-axis and a rotation about the y-axis.

13. The method of claim 8, further comprising determining a duck dive depth, wherein the duck dive depth is determined as a function of a double integration of an inner product of an acceleration along the x-axis and an acceleration along the z-axis.

14. The method of claim 8, further comprising displaying, via a display on the motion capture element, at least one of: a top speed, a duration of time spent on a wave, a distance traveled on a wave, a top acceleration, a number of turns executed on a wave, a duration of time spent paddling, a total duration of time spent riding waves, a total distance traveled in a body of water, and a total distance traveled while riding waves.
